(19) United States
(12) Patent Application Publication
(10) Pub. No.: US 2015/0111017 A1
(43) Pub. Date: Apr. 23, 2015

(54) Packaging Tape

(71) Applicant: 3M INNOVATIVE PROPERTIES COMPANY, St. Paul, MN (US)

(72) Inventors: Peter B. Hogerton, White Bear Lake, MN (US); Jayshree Seth, Woodbury, MN (US); Shujun J. Wang, Woodbury, MN (US)

(73) Assignee: 3M INNOVATIVE PROPERTIES COMPANY, St. Paul, MN (US)

(21) Appl. No.: 14/395,838

(22) PCT Filed: Apr. 30, 2013
(86) PCT No.: PCT/US2013/038714

§ 371 Date: Oct. 21, 2014

Related U.S. Application Data
(60) Provisional application No. 61/642,061, filed on May 3, 2012.

(51) Int. Cl. C09J 7/02

(52) U.S. Cl. CPC C09J 7/0275; C09J 7/0246; C09J 2201/122; C09J 2201/606; C09J 2421/00; C09J 2423/106
USPC 428/216; 428/343; 428/337; 428/336; 428/213; 428/355 R; 428/355 BL

(57) ABSTRACT

There is provided a tape comprising a polypropylene backing having a thickness of at least 0.0254 mm and a synthetic rubber pressure sensitive adhesive having a thickness of at least 0.0229 mm, wherein the tape has a ratio of pressure sensitive adhesive to polypropylene backing thickness of at least 0.7:1.

### FIELD

The present disclosure relates to packaging, or carton sealing tape having a polypropylene backing and synthetic rubber pressure sensitive adhesive thereon.

### BACKGROUND

Corrugated carton materials are commodity products, and properties vary widely from supplier to supplier, location to location, and material lot to material lot. Certain types of carton materials have characteristics that make it difficult for carton sealing tapes to adhere and provide stable carton closure. In these instances, it is not uncommon for the carton seals to fail. The typical mode of failure is an adhesive failure, i.e. the tape pops-off cleanly from carton. The pop-off can occur within a few minutes, hours, or days from the time that the carton was sealed, and it can happen with no external stimulus other than the residual internal stresses in the carton seal itself.

Since the early 1990s, there has been a growing trend in usage of recycled fibers in containerboards. A growing percentage of cartons contain 100% recycled fibers, and even so-called “Kraft” linerboards contain as much as 30% recycled fibers. The quality of recycled fibers varies with time. There are short-term fluctuations which occur on top of a more gradual long term downward trend in quality, exemplified by shorter fiber lengths and higher percentages of fines. These pulp characteristics contribute to a net reduction in the amount of fiber to fiber bonding occurring in the linerboards and corrugating mediums. Generally speaking, as demand for pulp increases, the quality of recycled fibers tends to drop. As fiber quality drops, the amount of fiber-to-fiber bonding drops.

One way to reduce packaging waste is to minimize the weight of the carton material. This and the other disclosed factors serve to increase variability of carton properties over time. Using lower grade fibers, as well as the moving to lower basis weight papers, generally leads to the production of containerboards that are flimsier, mushier, rougher, and less porous. All of these features can substantially compromise the ability to achieve a good bond of a packaging tape to the carton itself.

Pressure sensitive adhesive (PSA) packaging sealing tape products fall into four adhesive families: hotmelt synthetic rubbers, water-based acrylics, solvent-based acrylics, and solvent-based natural rubbers. The hot melt synthetic rubbers use PSAs formulated from some type of styrenic block copolymer (SIS, SBS, and blends thereof, and the like), some type of solid tackifying resin (hydrocarbon resin, polyterpene, rosin ester, and blends thereof, and the like) and optionally some type of plasticizer (liquid resin or oil). None of the presently available solutions provide consistently reliable adhesion in corrugated carton sealing applications.

There exists a need for a packaging tape and adhesives used therein for consistently reliable adhesion in corrugated box sealing applications.

### SUMMARY

The present disclosure provides a packaging tape and adhesives used therein for consistently reliable adhesion in corrugated box sealing applications.0

Thus, in one aspect, the present disclosure provides a tape comprising a polypropylene backing having a thickness of at least 0.0254 mm (0.001 inches) and a synthetic rubber pressure sensitive adhesive having a thickness of at least 0.0229 mm (0.0009 inches), wherein the tape has a ratio of pressure sensitive adhesive to polypropylene backing thickness of at least 0.7:1. In some embodiments, the polypropylene is a biaxially oriented polypropylene. In some embodiments, the synthetic rubber pressure sensitive adhesive comprises a hot melt synthetic rubber.

In some embodiments, the synthetic rubber pressure sensitive adhesive comprises at least 35% but not more than 55% of a block copolymer with more than 50% tri-block content and less than 50% di-block. In some embodiments, the synthetic rubber pressure sensitive adhesive comprises at least 35 wt % but not more than 50 wt % of a solid tackifying resin having a glass transition temperature of less than 70° C. In some embodiments, the synthetic rubber pressure sensitive adhesive comprises from 0 wt % to 25 wt % of a liquid plasticizer of either an oil or a liquid resin possessing a glass transition temperature of less than −10° C.

In some embodiments, the synthetic rubber pressure sensitive adhesive comprises: at least 35 wt % but not more than 55 wt % of a block copolymer with more than 50 wt % tri-block content and less than 50 wt % di-block; at least 35% but not more than 50% of a solid tackifying resin having a glass transition temperature of less than 70° C.; and from 0 wt % to 25 wt % of a liquid plasticizer of either an oil or a liquid resin possessing a glass transition temperature of less than −10° C. In some embodiments, the synthetic rubber pressure sensitive adhesive comprises: at least 37 wt % but not more than 47 wt % of a block copolymer with more than 75 wt % tri-block content and less than 20 wt % di-block; at least 37 wt % but not more than 47 wt % of a solid tackifying resin having a glass transition temperature of less than 70° C.; and from 13 wt % to 25 wt % of a liquid plasticizer of either an oil or a liquid resin possessing a glass transition temperature of less than −10° C.

In some embodiments, the polypropylene backing has a thickness of at least 0.0012 mm (0.0012 inches). In some embodiments, the synthetic rubber pressure sensitive adhesive has a thickness of at least 0.0203 mm (0.0008 inches). In some embodiments, the ratio of pressure sensitive adhesive to polypropylene backing thickness of at least 0.75:1

In some embodiments, the solid tackifying resin is selected from at least one of a hydrocarbon tackifying resin, a polyterpene, and a rosin ester. In some embodiments, the liquid resin is selected from at least one of a hydrocarbon tackifying resin, a polyterpene, and a rosin ester.

In another aspect, the present disclosure provides a tape comprising a backing and a pressure sensitive adhesive comprising a hot melt synthetic rubber comprising: at least 35 wt % but not more than 55 wt % of a block copolymer with more than 50 wt % tri-block content and less than 50 wt % di-block; at least 35 wt % but not more than 50 wt % of a solid tackifying resin having a glass transition temperature of less than 70° C.; and from 0 wt % to 25 wt % of a liquid plasticizer of either an oil or a liquid resin possessing a glass transition temperature of less than −10° C., and wherein the tape exhibits at least 0.9 kg-force of low-angle de-bonding energy when bonded to a low grade corrugate.

In some embodiments, the synthetic rubber pressure sensitive adhesive comprises: at least 37 wt % but not more than 47 wt % of a block copolymer with more than 70 wt % tri-block content and less than 20 wt % di-block; at least 37 wt % but not more than 47 wt % of a solid tackifying resin having a glass transition temperature of less than 70° C.; and from 13 wt % to 25 wt % of a liquid plasticizer of either an oil or a liquid resin possessing a glass transition temperature of less than −10° C.

In some embodiments, the polypropylene backing has a thickness of at least 0.0012 mm (0.0012 inches). In some embodiments, the synthetic rubber pressure sensitive adhesive has a thickness of at least 0.0203 mm (0.0008 inches). In some embodiments, the ratio of pressure sensitive adhesive to polypropylene backing thickness of at least 17.018 mm 0.7:1

In some embodiments, the solid tackifying resin is selected from at least one of a hydrocarbon tackifying resin, a polyterpene, and a rosin ester. In some embodiments, the liquid resin is selected from at least one of a hydrocarbon tackifying resin, a polyterpene, and a rosin ester.

In some embodiments, the block copolymer is selected from at least one of SIS styrene-isoprene-styrene (SIS), styrene-isoprene-butadiene-styrene (SIBS), styrene-butadiene-styrene (SBS), styrene-ethylene-butadiene-styrene (SEBS), styrene-butadiene (SB), ethylene-propylene-diene, hydrogenation products thereof, and combinations thereof. In some embodiments, the block copolymer is styrene-isoprene-styrene block copolymer.

Various aspects and advantages of exemplary embodiments of the present disclosure have been summarized. The above summary is not intended to describe each illustrated embodiment or every implementation of the present disclosure. Further features and advantages are disclosed in the embodiments that follow. The Drawings and the Detailed Description that follow more particularly exemplify certain preferred embodiments using the principles disclosed herein.

### DETAILED DESCRIPTION

As used in this Specification, the recitation of numerical ranges by endpoints includes all numbers subsumed within that range (e.g. 1 to 5 includes 1, 1.5, 2, 2.75, 3, 3.8, 4, and 5, and the like).

Unless otherwise indicated, all numbers expressing quantities or ingredients, measurement of properties and so forth used in the Specification and embodiments are to be understood as being modified in all instances by the term “about.” Accordingly, unless indicated to the contrary, the numerical parameters set forth in the foregoing specification and attached listing of embodiments can vary depending upon the desired properties sought to be obtained by those skilled in the art utilizing the teachings of the present disclosure. At the very least, and not as an attempt to limit the application of the doctrine of equivalents to the scope of the claimed embodiments, each numerical parameter should at least be construed in light of the number of reported significant digits and by applying ordinary rounding techniques.

For the following defined terms, these definitions shall be applied for the entire Specification, including the claims, unless a different definition is provided in the claims or elsewhere in the Specification based upon a specific reference to a modification of a term used in the following Glossary:

### GLOSSARY

The words “a”, “an”, and “the” are used interchangeably with “at least one” to mean one or more of the elements being described.

The term “layer” refers to any material or combination of materials on or overlaying a substrate.

The term “(co)polymer” or “(co)polymeric” includes homopolymers and copolymers, as well as homopolymers or copolymers that may be formed in a miscible blend, e.g., by coextrusion or by reaction, including, e.g., transesterification. The term “copolymer” includes random, block, graft, and star copolymers.

The present disclosure provides a tape having a polypropylene backing having a thickness of at least 0.0254 mm (0.001 inches) and a synthetic rubber pressure sensitive adhesive having a thickness of at least 0.0229 mm (0.0009 inches), wherein the tape has a ratio of pressure sensitive adhesive to polypropylene backing thickness of at least 0.7:1.

Components of hot melt rubber pressure sensitive adhesive, such as the presently disclosed synthetic rubber pressure sensitive adhesive, are a mixture of a thermoplastic rubber, a solid tackifier and a liquid tackifier resins, or a blends of solid tackfier and liquid plasticizer and/or liquid tackifier resin. The solid tackifier and liquid tackifer or plasticizer/oil are provided in amounts to provide an adhesive having a composite midblock glass transition temperature of less than −5° C., preferably greater than −30° C.

In the present disclosure, the thermoplastic rubber means hot melt coatable synthetic rubber block copolymers, which include one or more synthetic rubber block copolymers that preferably are of the ABA- or AB-block type, where A is a hard thermoplastic block and B is a rubbery elastomeric block. The block copolymers can be linear, branched, radial, and combinations thereof. Examples of suitable block copolymers include styrene-isoprene-styrene (SIS), styrene-butadiene-styrene (SBS), styrene-isoprene-butadiene-styrene (SIBS), styrene-ethylene-butadiene-styrene (SEBS), styrene-butadiene (SB), ethylene-propylene-diene, and hydrogenation products thereof.

Suitable commercially available block copolymers having a styrene content from about 15% to about 35% by weight in the copolymer and an A-B type of diblock copolymer content from about 0% to about 50% by weight in the copolymer. e.g., those block copolymers available under product numbers 1161, 1163, 1117, 1111, and 1171 from Kraton Chemical Company under the trade designation “KRATON”. Other useful commercially available block copolymers include those available under the trade designation “QUINTAC” series block copolymers, available from Zeon Corporation, Tokyo, Japan.

The solid or liquid tackifer resins can be selected from the group of resins at least partially compatible with the elastomeric phase. Such tackifier resins include hydrocarbon resins, rosin esters and rosin acids; mixed aliphatic/aromatic tackier resins; polyterpene tackifier resins; terpene/aromatic tackifer resins; and hydrogenated tackifer resins. The hydrogenated resins can include resins made from the polymerization and subsequent hydrogenation of a feedstock consisting mostly of dicyclopentadiene; resins produced from the polymerization and subsequent hydrogenation of pure aromatic feedstock such as styrene, alphamethylstyrene, vinyl toluene; resins fashioned from the polymerization and subsequent hydrogenation of an unsaturated aromatic feedstream where in the feed stream mainly contains species having from 7 to 10 carbon atoms; hydrogenated polystyrene resins; and hydrogenated aliphatic and aliphatic/aromatic resins and rosin esters. In some embodiments, preferred tackifier resins include the hydrocarbon resins, the polyterepene resins, and terepene/aromatic resins. In some embodiments, especially preferred tackifier resins are the hydrocarbons, such as aliphatic C5 petroleum resin or aromatic C5/C9 copolymerized petroleum resin.

Preferably, the solid tackifier resin used is one that is compatible with the elastomeric block and has a softening point (ASTM E-28-67) between 65° C. and 105° C., for example, “ESCOREZ 2510” from Exxomobil Chemical, TX, “PICCOTAC 9095” from Eastman, TN, Wingtack plus from Cray Valley, PA, ets.; and the liquid tackifier resin used is one having a softening point (ASTM E-28-67) between −5° C. to 30° C., for example, REGALREZE 1018″ from Exxomobil chemical, TX, “ESCOREZE 2520” from Eastman, TN, Sylvares A25 from Arizonal Chemical, AZ, WINGTACK 10″ from Cray Valley, PA, PICCOLYTE A25″ (252) from Pinova Inc., GA, etc. The liquid plasticizers suitable for use in the presently disclosed rubber pressure sensitive adhesive include naphthenic oils and paraffinic oils, mineral oils.

The presently disclosed synthetic rubber pressure sensitive adhesive is coated on the backing with a specific thickness based on the desired application for the tape. For example, in some embodiments, the synthetic rubber pressure sensitive adhesive has a thickness of equal to or greater than 0.020 mm, 0.023 mm, 0.025 mm, 0.027 mm, 0.029 mm, and even 0.031 mm.

Useful backing materials for the presently disclosed tape include films and layers of various stiffnesses. Preferred backings are flexible.

Suitable backing materials include, e.g., polymeric films and layers, paper (e.g., treated paper) films and layers, layers of non-wovens, and combinations thereof. Useful polymeric films and layers include, for example, polyolefin polymers, monoaxially oriented polypropylene (MOPP), biaxially oriented polypropylene (BOPP), simultaneously biaxially oriented polypropylene (SBOPP), polyethylene, copolymers of polypropylene and polyethylene, polyester polymers, polycarbonate polymers, polymethacrylate polymers, cellulose acetate, polyester (e.g., biaxially oriented polyethylene terephthalate), vinyl acetates, and combinations thereof. Useful backings also include surface modified backings modified by, e.g., flame treatment, corona treatment, and roughening.

In some embodiments, preferred backing material includes an oriented polymeric film selected from the group consisting of polyolefin, polyester, and combinations thereof. In some embodiments, preferred backings have a thicknesses between 20 gm and 3,000 gm, preferably between 20 gm and 1,000 gm, more preferably between 25 um and 100 um.

A typical backing for packaging tape is polypropylene film. The predominant supply of this kind of film is a biaxially oriented backing from a film tenter line in order to control caliper or gauge profile so that the film backing can be uniformly coated with adhesive. When clear adhesives are used, the film backing must also be clear so that the resultant rolls of tape from such components are aesthetically pleasing. In a typical tape configuration, the film backing has a layer of adhesive on one side, and a layer of release coat material on the other side so that when placed in roll form for tape dispensing, the separation of one layer from the rest of the roll is facilitated.

Typically, however, film strengths in the tape direction (the tape longitudinal direction) in common packaging tapes do not exceed about 180 N/mm², in the case of tapes that use an industry standard of 0.050 mm thickness for the film backing of typically competitive packaging, mailing and packaging tapes. The tape's tensile strength is primarily due to the film backing of the tape. While strength may be enhanced by using thicker film backings, the level of film stiffness then increases and the tape, at some point, fails to conform well to the packages to which it is applied. Moreover, using thicker film backings makes such tape proportionately more costly. Thus, it is desirable to use a thinner backing in the presently disclosed packaging tape. For example, in some embodiments, the backing has a thickness of equal to or greater than 0.0010 mm, 0.0012 mm, 0.0016 mm, 0.0018 mm, 0.010 mm, 0.012 mm, 0.014 mm, 0.016 mm, 0.018 mm, 0.020 mm, 0.025 mm, 0.030 mm, 0.035 mm, 0.040 mm and even 0.045 mm.

The presently disclosed tape is useful in a variety of applications. One such application is use as a packaging tape. In some embodiments, the presently disclosed tape is particularly useful as packaging tape for low grade corrugate box materials, such as those having high recycled fiber content.

Two large-scale trends have emerged in the past two decades that have resulted in noticeable changes to a growing percentage of corrugated containerboards, or carton material, produced not only in the US but around the world. These trends are the light-weighting of cartons and the recovery and recycling of cartons. As these trends have progressed, increasing numbers of boxes have been encountered for which polymer film-based carton sealing tapes exhibit inferior adhesion. The manifestation of the problem is premature pop-off of the tapes from the carton s. The purpose of the present disclosure is to provide carton, or box, sealing tapes that exhibit improved performance to such carton s.

The Edge-Crush Test (ECT) became an alternative to the Mullen Burst Strength test for characterizing and certifying different grades of carton strength. The majority of cartons were historically certified by the Mullen test. Relatively recently, the majority of cartons are certified by the ECT. Mullen certification carries a minimum basis weight requirement, whereas ECT certification does not. The shift toward ECT and away from Mullen certification of cartons enables box manufacturers to seek ways to maintain the performance ratings while minimizing the amount of fiber in the carton.

The ECT rates the ability to stack cartons on a pallet, so it is a measure of the resistance to buckling along the axis parallel to the flutes of the containerboard. Many carton manufacturers have found ways to maintain edge crush ratings while reducing board weights by more than 10%. For example, in 1996 a 36-26-36 lb/MSF construction was typical for the commonly used 32 lb/in ECT rated containerboard. Recently, the same ECT rating has been achieved with a 31-26-31 construction, a net fiber reduction of 10.2%.

In addition to these basis weight reductions, carton manufacturers are increasingly being asked to produce cartons with lower ECT ratings than in the past so that their customers can further reduce packaging waste and costs. One example of a reduced ECT rating is a 24-23-24 lb/MSF construction which is rated at 29 lb/in.—an additional 21% fiber reduction relative to the 31-26-31 construction that carries a 32 lb/in ECT rating.

With the trend toward lighter and lighter containerboard constructions, even if the ECT rating is maintained with a lighter weight board construction, other properties are not. In particular, the flexural stiffness of the walls of such cartons tends to be lower than that of higher basis weight cartons. Also, as the basis weight of linerboards and corrugating medium are decreased, the resulting containerboards are more susceptible to “bruising” (i.e. permanent deformation of the fluting during normal handling), which can even further reduce flexural stiffness. It is significantly more difficult to obtain high quality carton seals on cartones having low flexural stiffness because it is more difficult to obtain good wetting of the pressure sensitive adhesive to the carton

Recovery and use of recycled fiber in containerboard production has grown steadily since the early 1990's. In the future, corrugated containerboards produced primarily with recycled fibers are projected to increasingly replace corrugated containerboards made without recycled fiber.

In general, unrefined fibers that are recovered from Old Corrugated Containers (OCC) are shorter and more brittle compared with virgin softwood fibers, and the percent fines (i.e. fibers with length less than approx. 0.2 mm) is significantly higher. Thus, without wishing to be bound by theory, papers and containerboards produced primarily with recycled fibers tend to exhibit reduced stiffness, as well as reduced resistance to tearing and bruising compared to virgin kraft papers.

The properties of recycled fibers also vary more widely over time compared to virgin kraft fibers. When demand is high, the overall quality of recycled fibers tends to be lower. As the use of recycled fiber grows, the average freeness of unrefined OCC pulp has steadily declined and become more erratic. Drops in freeness indicate a drop in average fiber length and/or and increase in the percentage of fines in the pulp. Because of at least these challenges, the presently disclosed tape surprisingly provides more consistently reliable adhesion to containerboard, or cartons, made using a high volume of recycled fiber.

In some embodiments, it is desirable to provide a specific ratio of the thickness of synthetic rubber pressure sensitive adhesive to the thickness of polypropylene backing for use in packaging tape applications. For example, in the presently disclosed tapes, useful ratios of the thickness of the synthetic rubber pressure sensitive adhesive to the thickness of polypropylene backing include 0.7:1, 0.75:1, 0.8:1, 0.85:1, 0.9:1, 0.95:1, and even 1:1.

In some embodiments, the pressure sensitive adhesive for the presently disclosed tape includes: at least 35 wt % but not more than 55 wt % of a block copolymer with more than 50 wt % tri-block content and less than 50 wt % di-block; at least 35% but not more than 50% of a solid tackifying resin having a glass transition temperature of less than 70° C.; and from 0 wt % to 25 wt % of a liquid plasticizer of either an oil or a liquid resin possessing a glass transition temperature of less than −10° C. In some embodiments, the pressure sensitive adhesive for the presently disclosed tape includes: at least 37 wt % but not more than 47 wt % of a block copolymer with more than 70 wt % tri-block content and less than 20 wt % di-block; at least 37 wt % but not more than 47 wt % of a solid tackifying resin having a glass transition temperature of less than 70° C.; and from 13 wt % to 25 wt % of a liquid plasticizer of either an oil or a liquid resin possessing a glass transition temperature of less than −10° C. In some embodiments, the amount of tri-block is more than 75 wt %, and even more than 80 wt %.

For producing the presently disclosed adhesive tapes, particular preference is given to backing made from biaxially oriented films based on polypropylene with a draw ratio in the lengthwise direction (machine direction, MD) of between 1:4 and 1:9, preferably between 1:4.8 and 1:6, and a draw ratio in the transverse direction (cross direction, CD) of between 1:4 and 1:9, preferably between 1:4.8 and 1:8.5. The moduli of elasticity achieved in the machine direction, measured at 10% elongation in accordance with ASTM D882, are normally situated between 1,000 and 4,000 N/mm² The moduli of elasticity achieved in the cross direction are likewise situated between 1 000 and 4 000 N/mm²

In some embodiments, the thicknesses of the biaxially oriented films are situated in particular between 15 and 100 μm, preferably between 20 and 50 μm. The biaxially oriented films can be produced on standard flat film lines, on which normally drawing is performed first in the machine direction and then in the cross direction. With this operation it is possible to set different properties in the machine and cross directions. The draw ratios in the machine direction are in particular between 1:4.5 and 1:6 (preferably from 1:4.8 to 1:5.6) and in the cross direction of between 1:7 and 1:9. By way of example, mention may be made of biaxially oriented films from Radici (Italy) with the trade designation “RADIL T” and from Mobil with the trade designation “BICOR OPP FILM 35 MB 250”. Also known in principle are biaxially oriented films which are drawn first in the machine direction, then in the cross direction, and finally in the machine direction once again.

Biaxially oriented films are produced in both single-layer and multilayer forms. In the case of the multilayer films, the thickness and composition with the different layers may be the same, although different thicknesses and compositions are known.

Preference for the presently disclosed tapes is given to multilayer, biaxially oriented films based on polypropylene with a sufficiently firm bond between the layers, since delamination of the layers in the course of manufacture or use of the adhesive tape is a disadvantage.

It is also possible to use biaxially oriented multilayer polyolefin films based on polypropylene whose surfaces have a clearly perceptible matteness as compared with standard polypropylene films. By way of example, mention may be made of biaxially oriented films from Radici (Italy) with the trade designation “RADIL™” and from Polinas (Turkey) with the trade designation “PILEN 225 D” and from Hoechst with the trade designation “TRESPAPHAN MAT” and from Bimo (Italy): “STILAN HP 32”. This matteness is produced by using special copolymers or polymer blends based on polyolefins which in the course of production by means of extrusion, with specially adapted drawing conditions, lead to sufficiently great surface roughness and, accordingly, to a matte appearance.

The surfaces of the films are treated by known techniques. Preference is given to surface treatments by corona treatment and/or by flame pretreatment. An overview of the techniques of surface treatment is contained, for example, in the article “Surface pretreatment of plastics for adhesive bonding” (A. Kruse, G. Kruger, A. Baalmann, and O.-D. Hennemann, J. Adhesion Sci. Technol., Vol. 9, No. 12, pp. 1611-1621 (1995).

The biaxially oriented films useful as the backing for the presently disclosed tapes are preferably corona- and/or flame-pretreated on the adhesive-facing side in order to obtain sufficient anchoring of the adhesive on the film. The surface tensions obtained in these operations are situated in particular between 35 and 47 mN/m and preferably between 38 and 45 mN/m.

The uncoated side can be surface treated prior to coating, directly after coating, or else in a separate workstep: for example, during slitting and rewinding. The surface treatment of the uncoated side takes place preferably after coating. Preference is given to a corona pretreatment which produces a surface tension, measured using standard commercial test inks, of from 30 to 45 mN/m, more preferably from 35 to 40 mN/m, and with particular preference from 36 to 38 mN/m. Likewise possible is a surface treatment by means of flaming.

Exemplary embodiments of the present disclosure have been described above and are further illustrated below by way of the following Examples, which are not to be construed in any way as imposing limitations upon the scope of the present disclosure. On the contrary, it is to be clearly understood that resort may be had to various other embodiments, modifications, and equivalents thereof which, after reading the description herein, may suggest themselves to those skilled in the art without departing from the spirit of the present disclosure and/or the scope of the appended claims.

### EXAMPLES

The following examples are intended to illustrate exemplary embodiments within the scope of this disclosure. Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements. At the very least, and not as an attempt to limit the application of the doctrine of equivalents to the scope of the claims, each numerical parameter should at least be construed in light of the number of reported significant digits and by applying ordinary rounding techniques.

### Test Methods

### Low Angle De-Bonding Energy Test

When a carton seal pops-off, the failure occurs via a gradual low-angle peeling that occurs in response to stresses imposed by the carton on the tape. Therefore, a new test method has been developed with the objective being to measure the de-bonding energy of a tape bond to a substrate at a low peeling angle and over a range of peeling rates called Low Angle De-Bonding Energy Test (LADE). The LADE test method utilizes a corrugated containerboard test coupon and includes the following steps:

1. Containerboard coupons of 3.81×7.62 centimeters are cut so that the corrugating flutes run parallel to the long dimension. The coupons are attached to a steel test panel using a two-sided adhesive transfer tape so that the top linerboard side is exposed (for example, transfer tape commercially available under the trade designation “#460” from 3M Company, St. Paul, Minn. can be used to adhere the coupon to the test panel).

2. A 2.54 cm wide by 12.7 cm long piece of carton sealing tape is rolled down onto a containerboard coupon using one pass of a 2.0 kg (4.5 lb) roller at ˜2.54 cm/s. The length of the tape runs parallel to the long dimension of the coupon and is centered on the coupon. The total bond area is 2.54 cm wide and 7.62 cm long. This is done so that there is a tail of carton sealing tape extending out from the leading edge of the coupon. This tail is reinforced with a 2.54 cm wide piece of filament tape.

3. A 5 minute lag time is prescribed between the rolldown and the peeling test.

4. The test sample is placed in a fixture that is mounted in the lower jaw of a tensile testing machine. The fixture is designed so that the test sample is oriented at a fixed angle from the vertical. An angle of 25 degrees has been normally used. (The tensile tester pulls in the vertical direction.)

5. The reinforced tape tail is slipped into and gripped by the upper jaw of the tensile tester.

6. The tensile tester is programmed to pull the tape from the coupon in such a way that the applied force increases linearly with time. Rates ranging from 0.0045 kg/s to 13.6 kg/s (0.01 lb/s to 30 lb/s) have been evaluated, and typically a rate of 0.9 kg/s (2 lb/s) is prescribed.

7. Tabular data is collected for instantaneous force, time and deflection. Total debonding energy is computed by integrating under the force versus. deflection curve. Results are stated in the unit of inch-pounds as the term of debonding energy for a 2.54×7.62 cm bond area.

The LADE test has been used to characterize a number of carton sealing tapes on a number of containerboard materials.

### Shear to Fiberboard

One of the principal test methods used to characterize performance of carton sealing tapes is “Shear to Fiberboard”, ASTM D3654/D3654M-06 (Reapproved 2011), Procedure B. It is widely accepted that this method provides a measure of the ability of a carton sealing tape to keep a carton closed over time. This property represents an important counterbalance as improved de-bonding energy is being sought.

Procedure B specifies the use of a reference standard fiberboard, NIST SRM 1810A (Mosinee Fiberboard), which actually bears little resemblance to actual carton materials. For experimental studies documented in this invention submission, the shear to fiberboard method was used not only with SRM 1810A, but also with a selection of linerboard materials that represent a cross-section of materials available at the present time.

Note that the LADE test method utilizes a corrugated containerboard substrate, whereas the shear test utilizes a linerboard substrate. By using matched sets of linerboards and containerboards, it is possible to obtain both shear and LADE data for a single carton material.

Tables 3 and 4 list matching linerboard and containerboard substrates that were used to collect performance test data shown in subsequent examples. The ID number of each linerboard material matches up with the ID number of the corresponding containerboard (i.e. these are matched sets). Set #20 is actually not a matched set but was treated as such. Sample sets #15 and #20 were used regularly as benchmark examples of “high grade” and “low grade” materials, respectively.

TABLE 3
Linerboard Substrates used in the Examples:

| LINERBOARDS | Producer | Mill | #/MSF | % Recy | % PCW |
|---|---|---|---|---|---|
| 1 | US Corrugated | Unknown | 35 | 100 | 77 |
| 2 | US Corrugated | Unknown | 56 | 100 | 90 |
| 3 | Temple Inland | Bogalusa, AL | 69 | 17 | 14 |
| 4 | Temple Inland | Bogalusa, AL | 33 | 17 | 14 |
| 5 | Pratt Industries | Staten Island, NY | 35 | 100 | 100 |
| 6 | Liberty Paper | Monticello, MN | 35 | 100 | 100 |
| 7 | Liberty Paper | Monticello, MN | 42 | 100 | 100 |
| 8 | Temple Inland | Ontario, CA | 37 | 100 | 100 |
| 9 | Green Bay | Green Bay, WI | 31 | 100 | 100 |
| | Packaging | | | | |
| 10 | Green Bay | Green Bay, WI | 42 | 100 | 100 |
| | Packaging | | | | |
| 11 | Temple Inland | Maysville, KY | 33 | 100 | Unknown |
| 12 | Temple Inland | Orange, TX | 33 | ~20 | Unknown |
| 13 | Int'l. Paper | Prattsville, IL | 33 | Unknown | Unknown |
| 14 | Int'l. Paper | Prattsville, IL | 56 | Unknown | Unknown |
| 15 | Temple Inland | Ontario, CA | 32 | 100 | 100 |
| 16 | Rengo | China | 51 | 100 | Unknown |
| 17 | Rengo | China | 41 | 100 | Unknown |
| 18 | RC | China | 51 | 100 | Unknown |
| 19 | RC | China | 41 | 100 | Unknown |
| 20 | Mosinee Control | Wausau, WI | 21 | 0 | 0 |

Notes:
1) #/MSF: Basis Weight, pounds per 92.9 square meters (1000 sq. ft.)
2) % Recy: % of recycled pulp used in the linerboard
3) PCW: “Post Consumer Waste”, a low grade pulp
4) All linerboards were obtained during calendar year 2011.

TABLE 4
Corrugated Boards used in the Examples (Matching to the Linerboards):

| | | | Rating (ECT or |
|---|---|---|---|
| CORRUGATEDS | Source | Location | Mullen) |
| 1 | US Corrugated | Unknown | 5.7 (32) ECT |
| 2 | US Corrugated | Unknown | 7.8 (44) ECT |
| 3 | Pratt Industries | Unknown | 19.3 (275) Mull. |
| 4 | Pratt Industries | Unknown | 14.0 (200) Mull. |
| 5 | Pratt Industries | Unknown | 5.7 (32) ECT |
| 6 | Liberty Carton | Golden Valley, | 14.0 (200) Mull. |
| | | MN | |
| 7 | Liberty Carton | Golden Valley, | 5.7 (32) ECT |
| | | MN | |
| 8 | Temple Inland | Santa Fe Springs, | 5.7 (32) ECT |
| | | CA | |
| 9 | Green Bay | Green Bay, WI | 5.7 (32) ECT |
| | Packaging | | |
| 10 | Green Bay | Green Bay, WI | 7.8 (44) ECT |
| | Packaging | | |
| 11 | Temple Inland | Unknown | Unknown |
| | (Hybrid) | | |
| 12 | Temple Inland | Unknown | Unknown |
| | (Hybrid) | | |
| 13 | Int'l. Paper | Unknown | 5.7 (32) ECT |
| 14 | Int'l. Paper | Unknown | 7.8 (44) ECT |
| 15 | Temple Inland | Ontario, CA | 5.7 (32) ECT |
| 16 | Rengo | China | Unknown |
| 17 | Rengo | China | Unknown |
| 18 | RC | China | Unknown |
| 19 | RC | China | Unknown |
| 20 | Liberty Carton | Golden Valley, | 14.0 (200) Mull. |
| | | MN | |

Notes:
1) ECT (Edge Crush Test) ratings are shown in units of kilogram per centimeter (pounds per inch).
2) Mullen (Burst) ratings are shown in units of kilograms per square centimeter (pounds per square inch).
3) All containerboards utilized “C” flutes
4) All containerboard samples were obtained during calendar year 2011.

### Comparative Examples

### Conventional Carton Sealing Tape Products from 3M

| | | | | | | | | | | | Shear | |
|---|---|---|---|---|---|---|---|---|---|---|---|---|
| | | | | | | | PSA | | LADE in N-m | | (min) | |
| | | | | | | | | Mid- | (in-lb) | | Avg. of 3 | |
| | | | Thickness in | | | | | block | Avg. of 3 | | Liner- | Liner- |
| | Product | | micrometers (mils) | | | PSA/ | | Tg | Corrugate | Corrugate | board | board |
| Ex. | Co. | ID | Film | Adh | Tot. | Film | Rubber:Resin | (deg C.) | #20 | #15 | #20 | #15 |
| CE1 | 3M | 369 | 25.4 | 15.2 | 40.6 | 0.60 | 1:1 | −15 | | | | |
| | | | (1.0) | (0.6) | (1.6) | | | | | | | |
| CE2 | 3M | 371 | 30.5 | 17.8 | 48.3 | 0.58 | 1:1 | −15 | 0.14 | 0.11 | 3098 | 291 |
| | | | (1.2) | (0.7) | (1.9) | | | | (1.25) | (0.95) | | |
| CE3 | 3M | 372 | 35.6 | 20.3 | 55.9 | 0.57 | 1:1 | −15 | | | | |
| | | | (1.4) | (0.8) | (2.2) | | | | | | | |
| CE4 | 3M | 373 | 40.6 | 22.9 | 63.5 | 0.56 | 1:1 | −15 | 0.34 | 0.16 | 11387 | 2413 |
| | | | (1.6) | (0.9) | (2.5) | | | | (2.97) | (1.41) | | |
| CE5 | 3M | 375 | 50.8 | 27.9 | 78.7 | 0.55 | 1:1 | −15 | | | | |
| | | | (2.0) | (1.1) | (3.1) | | | | | | | |

Note:
The 3M product offerings are virtually the same as those of its competitors for polymeric PSA carton sealing tapes utilizing tensilized polypropylene backings. These examples show that the film and adhesive thicknesses are always increased together. In this way, as the total tape thickness increases, the load-bearing capability of the tape also increases.

### Examples 1-12

### Effects of PSA Thickness, BOPP Thickness, and PSA Formulation on Performance

### PSA Formulations Used for Tape Construction Examples 1-12:

| | Kraton | Wingtack | | Wingtack | Irganox | | Midblock |
|---|---|---|---|---|---|---|---|
| | D1161 | Plus | Calsol | 10 | 1076 | | Tg |
| Formulation | (%) | (%) | (%) | (%) | (%) | Rubber:Resin | (° C.) |
| 1 | 46.7 | 46.7 | 5.6 | | 1.0 | 1:1 | −15 |
| 2 | 36.5 | 46.8 | | 15.7 | 1.0 | 1:1.7 | −10 |

The PSA coatings for all of the following examples were melt-blended in a multi-port, twin-screw extruder, and subsequently drop-die coated onto the specified oriented polypropylene tape backing. Processing temperatures ranged between 149° C. and 177° C. (300° F. and 350° F.).
Formulation 1 is typical of PSA formulations used in existing carton sealing tape products. Formulation 2 is somewhat more unique and provides a somewhat softer and stickier adhesive.

### Examples 1-12

| | | | | | | LADE in N-m | | Shear (min) | |
|---|---|---|---|---|---|---|---|---|---|
| | | | | | | (in-lb) | | Avg. of 3 | |
| | | Thickness in | | | | Avg. of 3 | | Liner- | Liner- |
| | | micrometers (mils) | | | PSA/ | Corrugate | Corrugate | board | board |
| Ex. # | PSA | Film | Adh | Tot. | Film | #20 | #15 | #20 | #15 |
| 1 | 1 | 30.5 | 14.0 | 45.7 | 0.46 | 0.31 | 0.16 | 150 | 17 |
| | | (1.2) | (0.55) | (1.8) | | (1.76) | (0.90) | | |
| 2 | 1 | 30.5 | 22.9 | 53.3 | 0.75 | 0.50 | 0.28 | 724 | 72 |
| | | (1.2) | (0.90) | (2.1) | | (2.85) | (1.60) | | |
| 3 | 1 | 30.5 | 24.1 | 55.9 | 0.79 | 0.74 | 0.35 | 1075 | 128 |
| | | (1.2) | (0.95) | (2.2) | | (4.23) | (2.00) | | |
| 4 | 1 | 25.4 | 23.6 | 48.3 | 0.93 | 0.82 | 0.32 | 541 | 66 |
| | | (1.0) | (0.93) | (1.9) | | (4.70) | (1.83) | | |
| 5 | 1 | 25.4 | 28.7 | 53.3 | 1.13 | 1.10 | 0.31 | 775 | 98 |
| | | (1.0) | (1.13) | (2.1) | | (6.18) | (1.76) | | |
| 6 | 1 | 25.4 | 32.2 | 58.4 | 1.27 | 1.36 | 0.47 | 1185 | 250 |
| | | (1.0) | (1.27) | (2.3) | | (7.76) | (2.70) | | |
| 7 | 2 | 30.5 | 12.4 | 43.1 | 0.41 | 0.25 | 0.18 | 235 | 12 |
| | | (1.2) | (0.49) | (1.7) | | (1.42) | (1.05) | | |
| 8 | 2 | 30.5 | 21.3 | 50.8 | 0.70 | 0.76 | 0.23 | 475 | 46 |
| | | (1.2) | (0.84) | (2.0) | | (4.34) | (1.34) | | |
| 9 | 2 | 30.5 | 29.2 | 58.4 | 0.96 | 1.18 | 0.51 | 1183 | 234 |
| | | (1.2) | (1.15) | (2.3) | | (6.76) | (2.94) | | |
| 10 | 2 | 25.4 | 17.0 | 43.2 | 0.67 | 1.02 | 0.31 | 547 | 82 |
| | | (1.0) | (0.67) | (1.7) | | (5.82) | (1.78) | | |
| 11 | 2 | 25.4 | 26.9 | 53.3 | 1.06 | 1.31 | 0.46 | 286 | 196 |
| | | (1.0) | (1.06) | (2.1) | | (7.50) | (2.64) | | |
| 12 | 2 | 25.4 | 35.3 | 61.0 | 1.39 | 1.46 | 0.62 | 500 | 172 |
| | | (1.0) | (1.39) | (2.4) | | (8.32) | (3.54) | | |

The 25.3 micrometer (1.0 mil) Oriented polypropylene film was obtained from Impex International group, and was one of their “PIT” films. The 30.5 micrometer (1.2 mil) oriented polypropylene film was produced internally by 3M, but was the functional equivalent to Inteplast AmTopp TT30.

### Performance Survey

### Comparative Examples 1-5, 20 Containerboards

| Linerboard | CE2 | CE4 | EX1 | EX6 | EX9 | EX12 |
|---|---|---|---|---|---|---|
| | | Shear Averages for Various Tape Examples | | | | |
| | | (minutes) | | | | |
| 1 | 1216.3 | 7111.0 | 118.6 | 595.7 | 517.3 | 499.3 |
| 2 | 395.7 | 3511.3 | 29.6 | 551.0 | 202.8 | 386.7 |
| 3 | 1480.7 | 7365.3 | 141.0 | 965.3 | 500.0 | 572.0 |
| 4 | 1575.7 | 6394.3 | 55.2 | 721.7 | 351.7 | 770.7 |
| 5 | 87.8 | 644.5 | 6.3 | 225.7 | 49.7 | 127.2 |
| 6 | 1397.0 | 6022.0 | 40.2 | 590.3 | 395.3 | 620.0 |
| 7 | 1021.0 | 3411.7 | 21.9 | 464.7 | 184.6 | 541.7 |
| 8 | 446.0 | 4125.7 | 21.0 | 249.3 | 121.1 | 250.7 |
| 9 | 907.0 | 6379.7 | 61.5 | 820.0 | 319.0 | 591.3 |
| 10 | 2122.3 | 15029.0 | 79.7 | 1148.7 | 637.0 | 1338.7 |
| 11 | 745.7 | 3924.7 | 23.9 | 335.0 | 89.8 | 341.0 |
| 12 | 262.0 | 2028.3 | 23.1 | 160.3 | 192.5 | 367.3 |
| 13 | 2493.0 | 11306.3 | 117.0 | 1240.0 | 494.0 | 913.7 |
| 14 | 1898.0 | 7632.0 | 291.7 | 1236.0 | 637.0 | 562.3 |
| 15 | 291.3 | 2413.3 | 27.8 | 263.3 | 238.3 | 324.3 |
| 16 | 1250.3 | 10995.0 | 390.7 | 584.3 | 939.3 | 701.3 |
| 17 | 1838.7 | 5793.0 | 353.7 | 1404.7 | 697.3 | 659.0 |
| 18 | 3229.3 | 9521.0 | 456.3 | 1350.3 | 1154.3 | 1368.3 |
| 19 | 1335.0 | 10306.0 | 518.0 | 762.7 | 525.3 | 672.0 |
| 20 | 3098.0 | 11387.3 | 487.7 | 711.3 | 792.3 | 1290.0 |
| | | LADE Averages for Various Tape Examples | | | | |
| | | (in-lb) | | | | |
| 1 | 1.19 | 1.58 | 1.24 | 3.92 | 3.57 | 5.58 |
| 2 | 0.98 | 1.57 | 1.22 | 4.38 | 3.75 | 5.67 |
| 3 | 1.16 | 1.86 | 1.52 | 5.63 | 6.66 | 8.65 |
| 4 | 1.20 | 1.74 | 1.15 | 5.96 | 5.48 | 7.16 |
| 5 | 1.05 | 1.45 | 1.08 | 3.26 | 3.43 | 6.00 |
| 6 | 1.06 | 1.37 | 1.04 | 2.83 | 3.39 | 4.33 |
| 7 | 1.07 | 1.11 | 1.21 | 3.14 | 2.80 | 3.48 |
| 8 | 1.11 | 1.35 | 1.06 | 3.60 | 2.74 | 4.62 |
| 9 | 1.31 | 1.58 | 1.30 | 3.95 | 4.44 | 4.97 |
| 10 | 1.77 | 2.47 | 1.65 | 6.37 | 5.69 | 9.74 |
| 11 | 1.13 | 1.59 | 1.09 | 3.23 | 3.59 | 4.86 |
| 12 | 1.03 | 1.57 | 1.08 | 3.72 | 3.74 | 4.86 |
| 13 | 1.77 | 1.99 | 1.56 | 5.20 | 5.65 | 6.54 |
| 14 | 1.11 | 1.66 | 1.22 | 5.27 | 4.03 | 6.77 |
| 15 | 0.95 | 1.41 | 1.07 | 2.87 | 2.62 | 2.53 |
| 16 | 1.13 | 1.86 | 1.50 | 6.51 | 3.44 | 8.99 |
| 17 | 0.90 | 1.45 | 1.38 | 7.15 | 3.21 | 6.97 |
| 18 | 1.67 | 2.59 | 2.31 | 6.46 | 5.57 | 9.53 |
| 19 | 1.01 | 1.79 | 1.31 | 7.27 | 2.69 | 6.97 |
| 20 | 1.25 | 2.97 | 1.59 | 4.08 | 6.35 | 7.66 |

While the specification has described in detail certain exemplary embodiments, it will be appreciated that those skilled in the art, upon attaining an understanding of the foregoing, may readily conceive of alterations to, variations of, and equivalents to these embodiments. Accordingly, it should be understood that this disclosure is not to be unduly limited to the illustrative embodiments set forth hereinabove. Furthermore, all publications, published patent applications and issued patents referenced herein are incorporated by reference in their entirety to the same extent as if each individual publication or patent was specifically and individually indicated to be incorporated by reference. Various exemplary embodiments have been described. These and other embodiments are within the scope of the following listing of disclosed embodiments.

1. A tape comprising a polypropylene backing having a thickness of at least 0.0254 mm (0.001 inches) and a synthetic rubber pressure sensitive adhesive having a thickness of at least 0.0229 mm (0.0009 inches), wherein the tape has a ratio of pressure sensitive adhesive to polypropylene backing thickness of at least 0.7:1.

2. The tape of claim 1 wherein the polypropylene is a biaxially oriented polypropylene.

3. The tape of any claim 1 wherein the synthetic rubber pressure sensitive adhesive comprises a hot melt synthetic rubber.

4. The tape of claim 1 wherein the synthetic rubber pressure sensitive adhesive comprises at least 35% but not more than 55% of a block copolymer with more than 50% tri-block content and less than 50% di-block.

5. The tape of claim 1 wherein the synthetic rubber pressure sensitive adhesive comprises at least 35 wt % but not more than 50 wt % of a solid tackifying resin having a glass transition temperature of less than 70° C.

6. The tape of claim 1 wherein the synthetic rubber pressure sensitive adhesive comprises from 0 wt % to 25 wt % of a liquid plasticizer of either an oil or a liquid resin possessing a glass transition temperature of less than −10° C.

7. The tape of claim 1 wherein the synthetic rubber pressure sensitive adhesive comprises:
a. at least 35 wt % but not more than 55 wt % of a block copolymer with more than 50 wt % tri-block content and less than 50 wt % di-block;
b. at least 35% but not more than 50% of a solid tackifying resin having a glass transition temperature of less than 70° C.; and
c. from 0 wt % to 25 wt % of a liquid plasticizer of either an oil or a liquid resin possessing a glass transition temperature of less than −10° C.

8. The tape of claim 1 wherein the synthetic rubber pressure sensitive adhesive comprises:
d. at least 37 wt % but not more than 47 wt % of a block copolymer with more than 75 wt % tri-block content and less than 20 wt % di-block;
e. at least 37 wt % but not more than 47 wt % of a solid tackifying resin having a glass transition temperature of less than 70° C.; and
f. from 13 wt % to 25 wt % of a liquid plasticizer of either an oil or a liquid resin possessing a glass transition temperature of less than −10° C.

9. The tape of claim 1 wherein the polypropylene backing has a thickness of at least 0.0012 mm (0.0012 inches).

10. The tape of claim 1 wherein the synthetic rubber pressure sensitive adhesive has a thickness of at least 0.0203 mm (0.0008 inches).

11. The tape of claim 1 wherein the ratio of pressure sensitive adhesive to polypropylene backing thickness of at least 0.75:1

12. The tape of claim 5 wherein the solid tackifying resin is selected from at least one of a hydrocarbon tackifying resin, a polyterpene, and a rosin ester.

13. The tape of claim 5 wherein the liquid resin is selected from at least one of a hydrocarbon tackifying resin, a polyterpene, and a rosin ester.

14. A tape comprising a backing and a pressure sensitive adhesive comprising a hot melt synthetic rubber comprising:
g. at least 35 wt % but not more than 55 wt % of a block copolymer with more than 50 wt % tri-block content and less than 50 wt % di-block;
h. at least 35 wt % but not more than 50 wt % of a solid tackifying resin having a glass transition temperature of less than 70° C.; and
i. from 0 wt % to 25 wt % of a liquid plasticizer of either an oil or a liquid resin possessing a glass transition temperature of less than −10° C., and wherein
the tape exhibits at least 0.9 kg-force of low-angle de-bonding energy when bonded to a low grade corrugate.

15. The tape of claim 14 wherein the synthetic rubber pressure sensitive adhesive comprises:
j. at least 37 wt % but not more than 47 wt % of a block copolymer with more than 70 wt % tri-block content and less than 20 wt % di-block;
k. at least 37 wt % but not more than 47 wt % of a solid tackifying resin having a glass transition temperature of less than 70° C.; and
l. from 13 wt % to 25 wt % of a liquid plasticizer of either an oil or a liquid resin possessing a glass transition temperature of less than −10° C.

16. The tape of claim 14 wherein the polypropylene backing has a thickness of at least 0.0012 mm (0.0012 inches).

17. The tape of claim 14 wherein the synthetic rubber pressure sensitive adhesive has a thickness of at least 0.0203 mm (0.0008 inches).

18. The tape of claim 14 wherein the ratio of pressure sensitive adhesive to polypropylene backing thickness of at least 17.018 mm 0.7:1

19. The tape of claim 14 wherein the solid tackifying resin is selected from at least one of a hydrocarbon tackifying resin, a polyterpene, and a rosin ester.

20. The tape of claim 14 wherein the liquid resin is selected from at least one of a hydrocarbon tackifying resin, a polyterpene, and a rosin ester.

21-22. (canceled)
